(19) United States
(12) Patent Application Publication
(10) Pub. No.: US 2004/0182599 A1
(43) Pub. Date: Sep. 23, 2004

(54) Insulation of the electrical connections of several flat flex cables

(76) Inventor: Van Hung Nguyen, Hemmigen (DE)

Correspondence Address: Merchant & Gould P.C., P.O. Box 2903, Minneapolis, MN, 55402-0903, US

(21) Appl. No.: 10/767,608

(22) Filed: Jan. 29, 2004

(30) Foreign Application Priority Data
Jan. 29, 2003 (EP) 03450030.6

(51) Int. Cl. H01B 7/00

(52) U.S. Cl. 174/138 D

(57) ABSTRACT

Insulation of the electrical connections of at least two flat flex cables (FFCs), which consist of at least electrical strip conductors and insulating material, wherein the insulating material is removed locally and the exposed strip conductors of different FFCs are joined with one another, a so-called matrix. The matrix is insulated with an insulating material, called sealing material, which is made of similar material, preferably of the same material as the insulating material of the FFCs. In a first variant, the sealing material is placed, as a liquid, in a mold on the matrix and hardened; in a second variant, the sealing material is present in the form of a film and is welded in a mold with the insulating material of the FFCs.

The invention concerns the insulation of the electrical connections of several flat flex cables, independent of their structure or their production: laminated, extruded, sealed, or also produced in another manner. In particular, the invention concerns an insulation of the electrical connections of at least two flat flex cables, so-called FFCs which consist of at least electrical strip conductors and insulation material, wherein the insulation material is removed locally and the exposed strip conductors of various FFCs are connected to one another in an electrically conducting manner, a so-called matrix.

For various reasons, mainly because of their automated manageability, flat flex cables, so-called FFCs, are used in industry, particularly in the construction of automobiles. The invention under consideration concerns the FFCs, in which individual strip conductors, parallel to one another and conducted in at least one common plane, are electrically insulated by insulating material from one another and with respect to the outside. For example, extruded FFCs are produced in such a manner that individual strip conductors are wrapped by an electrically insulating extrudate in special injection molding units, which extrudate insulates electrically the individual strip conductors from one another and the environment, and holds them mechanically.

For the formation of so-called cable harnesses, the conductors of the FFCs are soldered, welded, crimped, cemented, or connected with one another in another electrically conducting manner, perhaps in several layers, thus including more than two FFCs, directly—that is, without intermediate cables or plugs—after the removal of the insulating layers. The connecting site is finally again insulated from all of the components and from the environment, by the insulating material, namely by wrapping around it an electrically insulating film, which can be self-adhesive or which, after the application of adhesive, is wound around the matrix. Such a connecting site is generally called a “matrix” because of the grid-like arrangement of the individual connections in top view.

In addition to electrical insulation as a main function, the insulating material should fulfill other requirements, such as the absorption of mechanical stresses (tensile, torsion, peeling, vibration), sealing against water, hydrolysis resistance, the quality of not being easily flammable, and should make possible a good processability—all this at the lowest possible cost and with as automated an implementation as possible. The characteristics with regard to the recycling feasibility of the insulating material are also of special importance.

In almost all of the aforementioned concerns, the films used in the state of the art are far from the desired goal: Their handling is complicated and cannot be automated; the transfer of mechanical stresses is poor; the tightness is unsatisfactory; and the recycling characteristics are entirely insufficient.

From EP 1 157 892 A, an overview of the insulation methods known at the time of the application is given, wherein the protection of a matrix by a connection box is indicated as the mainly used state of the art. In order to avoid the various disadvantages (particularly the height of the construction) of this state of the art, already previously known at the time, the EP-A proposes to use, instead of a matrix, special connecting parts, constructed in a manner similar to conductor plates, but thinner, on which individual FFCs can be connected with butt joints. For the insulation, foils or films are used; nothing is said about their characteristics. The structure of these connections is complex; the connecting site, to be produced individually for each connection, plus the individual films to be applied, are expensive, and the production can be automated only with difficulty.

From U.S. Pat. No. 5,724,730 A, the straight-line transition between an FFC and several traditional round cables (one per strip conductor of the FFC) is disclosed. To this end, a so-called protection part is applied on the FFC close to the insulated end, which, as a result, is cast as a kind of “lost core,” partially in a shell made of thermoplastic or duroplastic material; nothing further is said about its characteristics. The cast part covers the entire transition range of the two cables and, in accordance with its size and wall thickness, forms a practically rigid body, from which the individual cables protrude abruptly to the outside. A use of this connection on other connections, particularly on a matrix, is not suggested and is not possible, either, because of the protection part and the mechanical characteristics of the cast part.

In piecing together high-voltage cables, insulated in several layers, with shielding characteristics of the individual layers coordinated precisely to one another, a method is known from EP 1 128 514 A for producing the insulation in the piecing together area, according to the same insulation system as in the area of the undisturbed conduit, in order to preserve the electrical characteristics of the cable. Nothing can be gleaned therefrom for the problem which is the basis of the invention.

From U.S. Pat. No. 6,078,012 A, a method is known for affixing a carrier plate in the area of the coaxial transition from an FFC to several round cables of an air bag control, on which selectable resistances in the circuit are mounted, so as to bring the total resistance of the electrical circuit to a predetermined value. Nothing can be gleaned therefrom for the problem which is the basis of the invention.

From GB 773 8832 A (1955), a method is known for repairing electrical round cables with only one conductor, in whose production the insulation is defective in some places, in that the insulation in a predetermined area is removed around the defect and [sic; the defect] is wrapped with a divided, movable mold and filled with insulating material and is thus repaired. Nothing can be gleaned therefrom for the problem which is the basis of the invention.

From DE 33 33 709 A, a “tap” for an FFC is known, in which the branching protrudes from the plane of the FFC. To this end, windows are placed in the FFC on the side of the tap and free ends of the branching FFC are joined with the exposed strip conductors. Then, an insulating body of unknown material that also serves as a grip, is injected around the tap. The branching FFC protrudes only somewhat from the insulating body and is insulated on its end, so that its strip conductors serve as a contact pin. Nothing can be gleaned therefrom for the problem which is the basis of the invention.

From U.S. Pat. No. 4,952,256 A, a coaxial connection between a round cable and FFC is known, in which the strand of the round cable is held by means of a ring and after the production of the electrical connection, is enclosed in an insulating block produced by means of injection molding. To this end, it is necessary to move at least one holding stamp for the ring in the mold, after the insulating material has already been introduced. Nothing can be gleaned therefrom for the problem which is the basis of the invention.

From DE 100 64 696 A, a method is known, wherein the film, which is used to cover a connection area (matrix) of the FFCs, is constructed larger than the matrix and the projecting part is used as the affixing point for the matrix. Nothing can be gleaned therefrom for the problem which is the basis of the invention.

Therefore, there is a great need for a better insulation for the matrices mentioned at the beginning and it is the goal of the invention to create such matrices, which can be produced, in particular, in an automated manner, in which the insulating material is to be recycled, just like the FFC; the mechanical stresses are to be transferred and borne well; there will be sufficient flexibility and elasticity in the area of the matrix also; and there will be a reliable tightness.

In accordance with the invention, these goals are attained in that the matrices will be insulated with a material similar to the insulating material, preferably the same material, which was used as the insulating material in their production in the course of the extrusion of the FFC. This material is called the “sealing material.”

“Similar material” is understood to mean a material whose chemical, mechanical, and thermal characteristics are similar to the insulating material, and which has sufficient electrical (insulating) characteristics. Such a material imparts to the matrix, after its production, the desired mechanical characteristics of sufficient strength and desired flexibility, with small dimensions and a firm (tight) union with the insulating material.

In a first variant of the invention, the sealing material is brought in molten form, as a liquid or thick liquid, within a mold around the matrix and by the subsequent effect of temperature and pressure in the mold is joined and hardened with the insulating material of the FFCs. The insulating die thereby has preferably two stamping surfaces, whose form is adapted to the matrix to be insulated.

In another variant of the invention, the sealing material is brought in film form, placed in one part, preferably, however, in two parts around the matrix and welded with one another and with the insulating material over the surface in the area of the matrix by the effect of temperature and pressure on the surface.

A particular advantage of the two variants is to be found in the fact that the sealing material and the insulating material of the FFCs in their characteristics are the same or at least so similar that they are joined, not only in the best-possible manner, but also without the aid of an adhesive, bonding agent, or the like.

The possibility of the matrix insulation described here produces insulations which have outstanding characteristics (high insulation resistance, absorption of high mechanical forces, watertight, and hydrolysis-resistant, to mention only a few). The processing processes for the insulation possibility described here can be implemented well for series production in an automated manner. The used sealing material is essentially more favorable, in comparison to materials which are coated with heat-crosslinking adhesives (laminates), viewed economically and also ecologically.

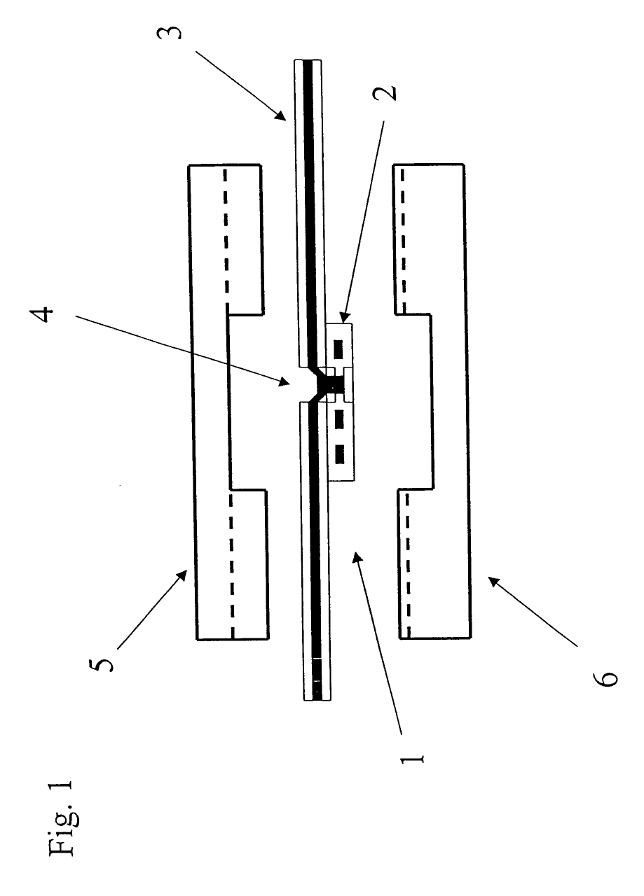

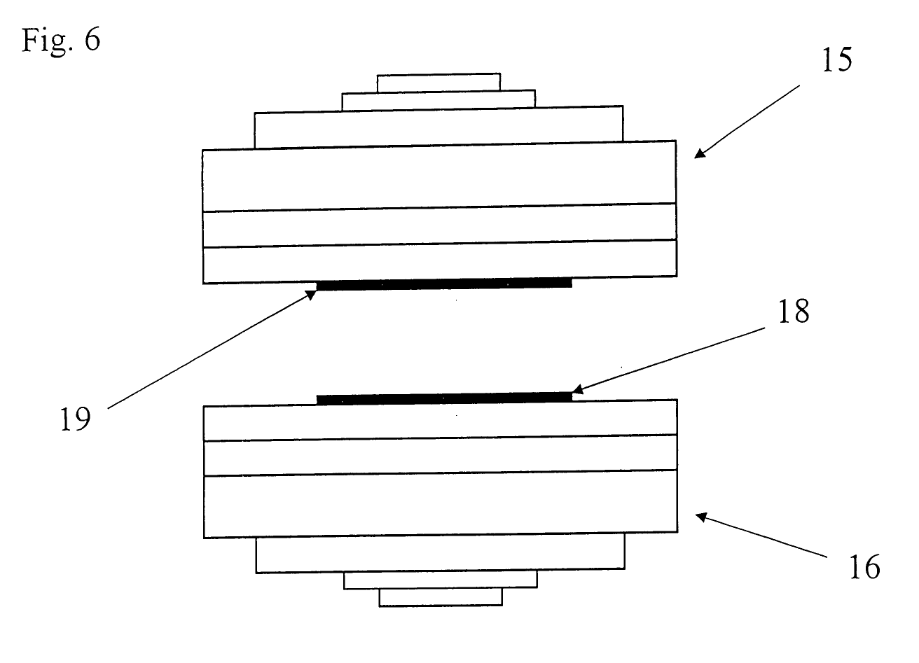

The invention is explained in more detail below, with the aid of the drawing. FIGS. 1 to 5 show the stepwise sequence of the first variant of the method of the invention, and FIGS. 6 to 9, the stepwise sequence of the second variant of the invention.

As can be seen from FIG. 1, FFCs 2 and 3, already connected with one another, whose connecting sites are designated with 4 and which, together, form a raw matrix 1, are appropriately positioned between two stamping parts, an upper stamp 5 and a lower stamp 6.

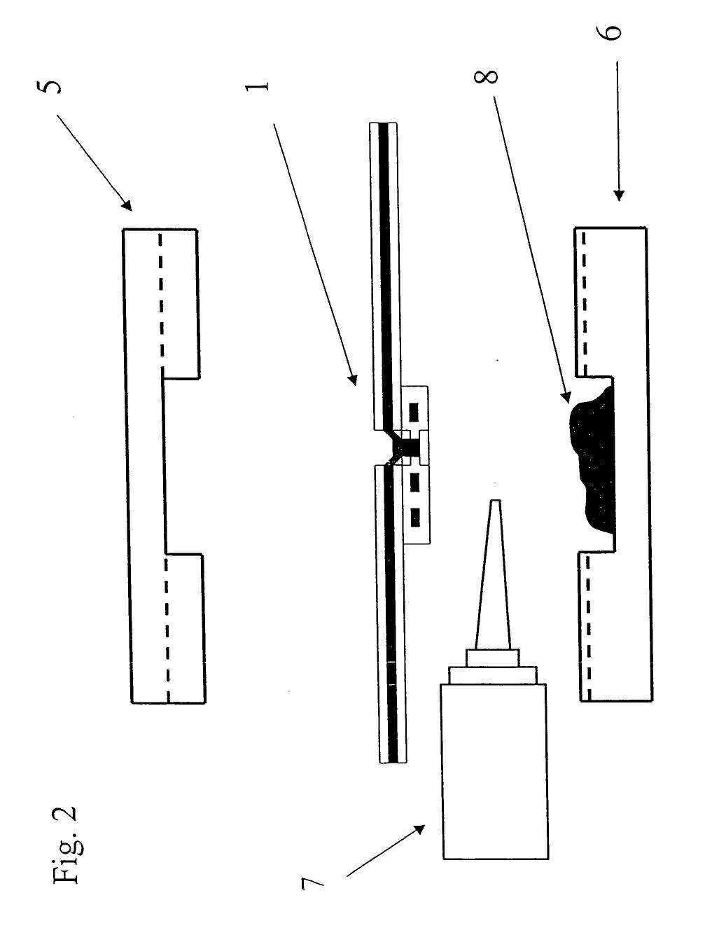

Then, as shown schematically in FIG. 2, sealing material is placed, using a release device for the sealing material, in liquid or paste form, on the lower stamp 6 in the area of its contact with the raw matrix 1; this applied quantity is schematically indicated with 8. As stated above already, the sealing material used is either the same material, like the insulating material, with which the conductors are wrapped in FFCs 2 and 3, or it is a similar material, which can be joined with this insulation material readily, well and permanently and is thus suitable for sheathing of the raw matrix.

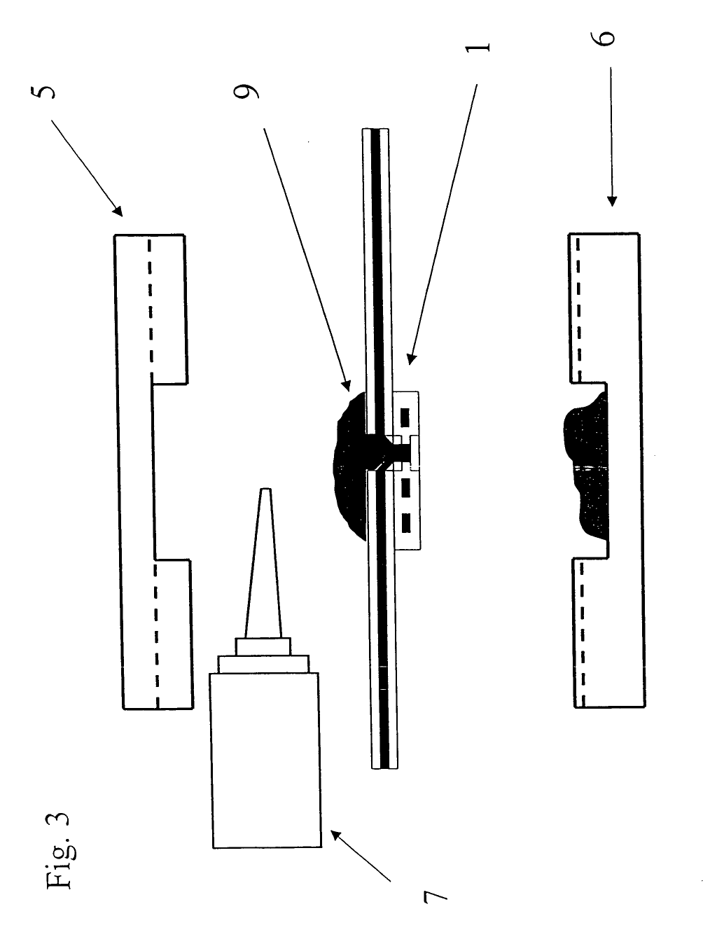

FIG. 3 shows the application of the sealing material on the raw matrix 1; in this way, a sufficient quantity of sealing material is obtained, so as to fill the mold around the raw matrix 1 and to reliably form an insulation of the raw matrix 1 on all sides.

It is, of course, possible to switch the steps shown in FIGS. 2 and 3 in their sequence, or also to undertake these steps simultaneously, by selecting a proper dispenser for each of the two application sites.

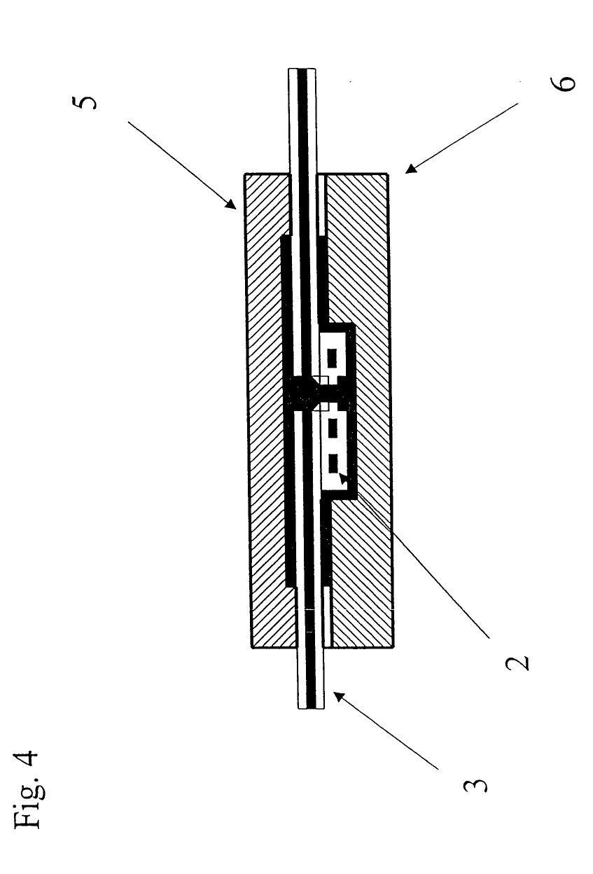

FIG. 4 shows the situation with a closed mold; by using pressure and temperature, the joining of the sealing material with the insulating material of the FFC and the hardening of the sealing material takes place.

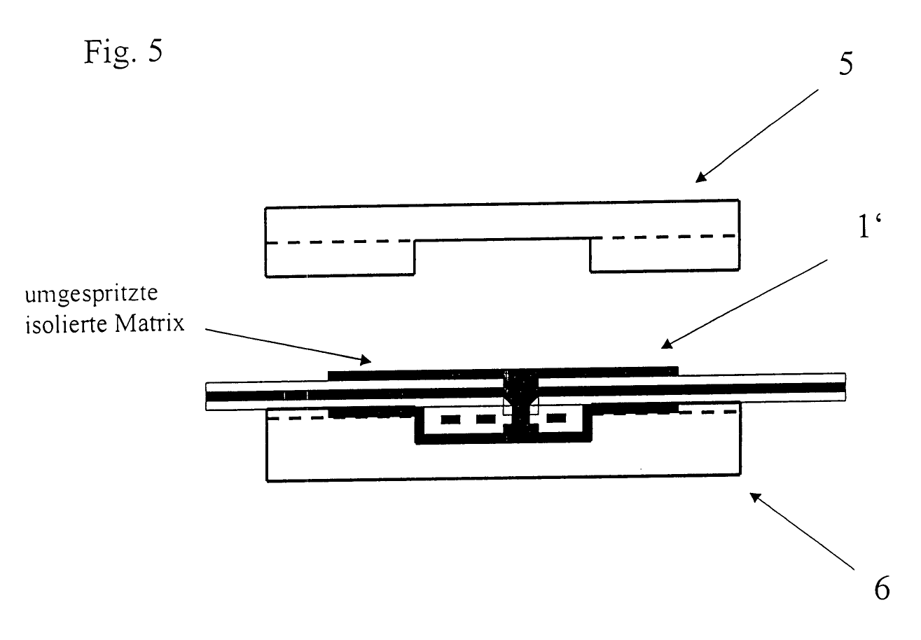

FIG. 5 shows the situation after the hardening has taken place, when the stamps are moved apart, either simultaneously or one after the other. The situation is shown, in which the upper stamp 5 with the corresponding upper half of the mold is lifted but the finished matrix 1′ still lies on the lower stamp 6. Then, either the matrix 1′ can be raised or the stamp 6 can be lowered, so as to be able to remove the finished matrix and to treat it further.

In a similar way, the sequence of the representation takes place according to FIGS. 6 to 9 in the course of the production of a matrix, in accordance with the invention and the second variant of the invention, wherein in order to be able to make a better comparison, elements corresponding to one another were designated with the same reference symbols as in the first variant of the invention, but with a number 1′ placed in front, whereas the same parts received the same reference symbols.

In FIG. 6, one can see the two stamps 15 and 16, which can optionally have a contour on their stamp surfaces which are directed toward one another, or they can be elastically formed, so as to be able to adapt to the contour of the matrix. The sealing material is arranged in the form of films 18, 19 on the two stamp surfaces. This can be secured by applying a vacuum or by using a weak adhesive.

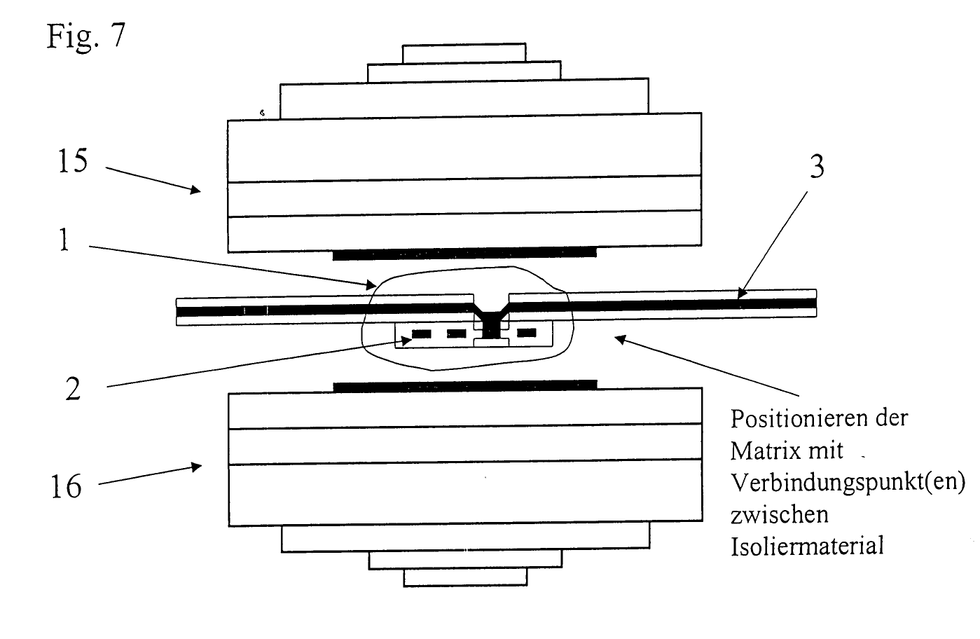

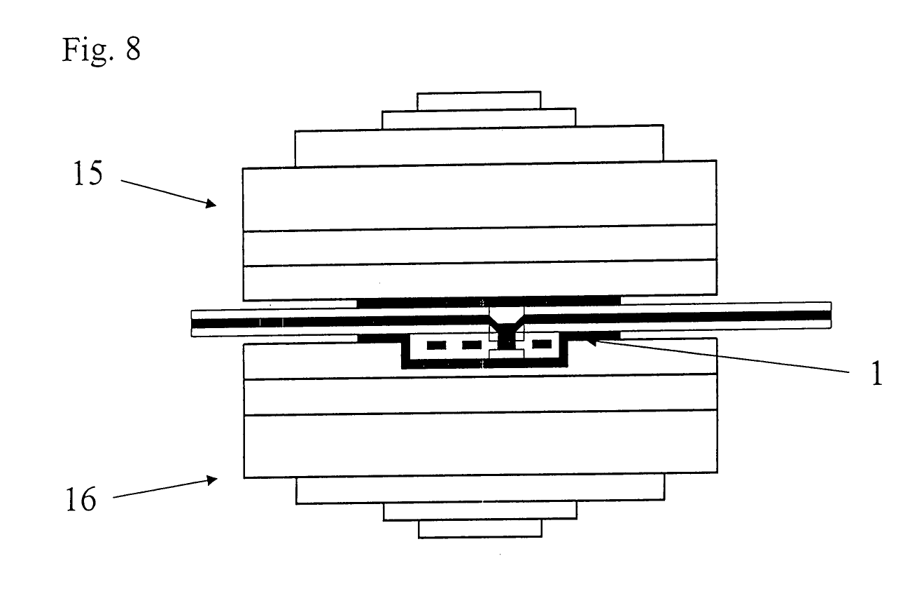

As can be seen from FIG. 7, the raw matrix is then, suitably positioned, brought between the two stamps 15, 16, and the stamps 15, 16 are closed, as shown in FIG. 8. Then, by using pressure and temperature, the connection between the films 18, 19 and the surface of the raw matrix 1 is formed, and the films 18, 19 are also suitably hardened, if this was not already the case before the joining. This is particularly the case if—as is preferred in this variant--the film parts are present in the form of so-called prepregs, as is familiar to a specialist in the area of plastic technology.

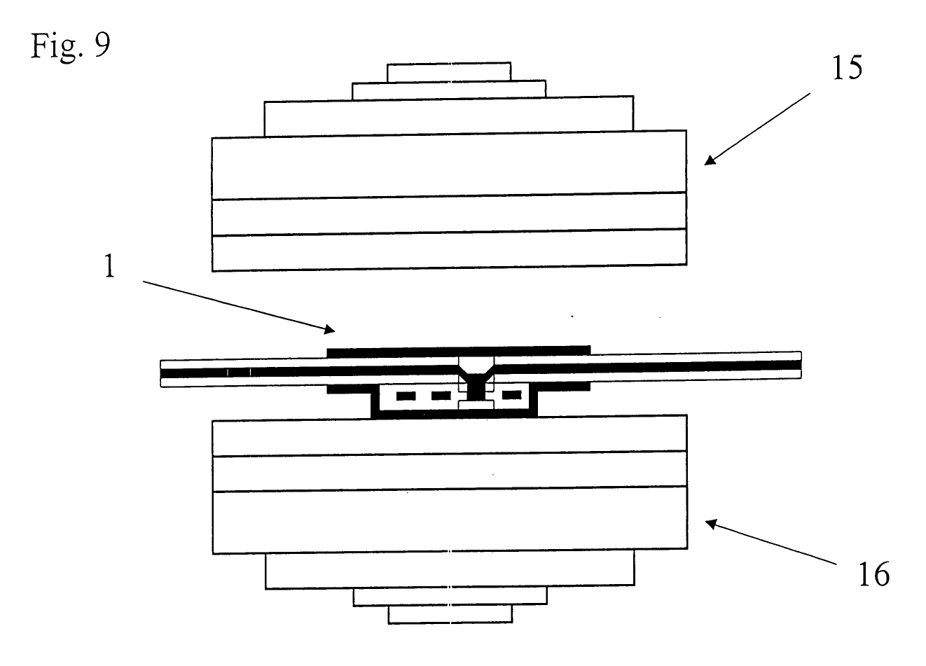

FIG. 9 shows the stamps 15, 16, again opened, after the finishing of matrix 1, analogous to FIG. 5, in the first variant of the invention.

Of course, the invention is not limited to the embodiment examples shown, but rather can be changed and modified in different ways. Thus, in each of the two variants, it is, in particular, possible to plan the movement of the two stamps differently, with respect to one another, from the movement in the embodiment example shown; both stamps can move or only one of the stamps; this movement can either be, as shown, a linear movement or, as is also common in automation, it can be a swiveling or folding, rolling or rotating movement; this can be easily selected by a specialist in the area of plastic processing with a knowledge of the invention and with a knowledge of the apparatuses or the neighboring stations available to him.

Thus, it is also possible to change the form of the insulation (for example, round, triangular, rectangular), in modification of the examples shown, and depending on the application case, the position of the insulation on the matrix can be different from the one shown.

In the description above, all the needed sensors, which monitor the opening and closing of the stamps, the correct placement of the raw matrix, the attaining and maintaining of the temperature needed or the pressure needed, were not described or depicted in the drawing, the heating and pressing devices nor the devices, sensors and controls, that are not directly concerned with the invention, but rather with its technical execution. All these things can be easily determined by a specialist in the area of plastic processing and, in particular, injection molding, with a knowledge of the invention, and can be selected from devices in the state of the art.

Some plastics, which can be used as the sealing material (granules) for the first variant of the invention are the following: polyamide (PA), polyvinyl chloride (PVC), thermoplastic polyurethane (TPU), polyethylene (PE), polypropylene (PP), polytetrafluoroethane (PTFE), polycarbonate (PC), ethylene and tetrafluoroethylene (ETFE), polyethylene terephthalate (PET).

Some sealing materials (in the form of films) which can be used for the second variant of the invention are the following: heat-crosslinking films based on thermoplastic polyurethane (TPU), polyethylene terephthalate (PET), polyethylene naphthalate (PEN), polyimide (PI), polyethylene (PE), polypropylene (PP), Polyvinyl chloride (PVC), polycarbonate (PC), polytetrafluoroethene (PTFE), ethylene and tetrafluoroethylene (ETFE), with simple or sandwich structure (double-layer or multilayer composite), with or without adhesive coating or cementing agent coating.

The thickness in which the sealing material used in accordance with the invention is applied preferably corresponds approximately to the thickness which the insulating material of the FFC has. Preferably, the thickness of the sealing material lies between one-fifth and threefold, with particular preference, between half and double the thickness of the insulating material of the FFC. The lower values are thereby preferred, if the sealing material is applied in the form of films, in particular, laminating films, and the upper values, if the sealing material is applied as granules or in paste form. The thickness of the sealing material is understood to mean the average value of the thickness, different in individual areas.

In this area of the thickness, a reliable mechanical protection exists, on the one hand, and the area of the matrix is still sufficiently flexible, on the other hand, so as not to hinder movements and deformations and not to allow the transition to the free FFC become a fracture site. In the joining of FFCs with different thicknesses of the insulation, the thickness of the sealing material is based, in the normal case, on the thinner insulating layer. Of course, especially if the insulating material of the or an FFC(s) has an unusual thickness, the thickness of the sealing material can be outside the indicated limits.

The FFCs, of course, can also contain other elements--for example, shielding nets or shielding conductors, or fiber-optical light guides for signals, and the like, without, in this way, leaving the scope of the invention.

1. Insulation of the electrical connections of at least two flat flex cables (FFCs) (2,3), which consist of at least electrical strip conductors and insulating material, wherein the insulating material is removed locally and the exposed strip conductors of different FFCs are joined with one another, in an electrically conducting manner, of a so-called matrix (1), characterized in that the matrix (1) is insulated with an insulating material, called sealing material, which consists of a similar material, preferably the same material as the insulating material of the FFCs.

2. Insulation of a matrix according to claim 1, characterized in that the thickness of the sealing material in the area of the matrix is between one-fifth and threefold, preferably between half and twice the thickness of the insulating material of the FFC.

3. Method for the production of an insulation according to claim 1 or 2, characterized in that the sealing material is placed in a molten form, as a liquid or thick liquid, within a mold (5,6) around the matrix (1) and by the subsequent action of temperature and pressure in the mold, is joined and hardened with the insulating material of the FFCs.

4. Method for the production of an insulation according to claim 1 or 2, characterized in that the sealing material is placed in the form of a film in one part, preferably, however, in two parts around the matrix (1) and is welded, over the surface, with itself or one with another and with the insulating material of the FFCs in the area of the matrix by the effect of temperature and pressure in a mold (15,16).

5. Mold to carry out the method according to one of claims 2-4, characterized in that the insulating material has two stamp surfaces, whose form is adapted to the insulating matrix.

6. Sealing material for use in the method according to claim 3, characterized in that it must be selected from the group consisting of the following: polyamide (PA), polyvinyl chloride (PVC), thermoplastic polyurethane (TPU), polyethylene (PE), polypropylene (PP), polytetrafluoroethene (PTFE), polycarbonate (PC), ethlyene and tetrafluoroethylene (ETFE), polyethylene terephthalate (PET).

7. Sealing material for use in the method according to claim 4, characterized in that it is selected from the group consisting of the following: heat-crosslinking films based on thermoplastic polyurethane (TPU), polyethylene terephthalate (PET), polyethylene naphthalate (PEN), polyimide (PI), polyethylene (PE), polypropylene OPP), polyvinyl chloride (PVC), polycarbonate (PC), polytetrafluoroethyene (PTFE), ethylene and tetrafluoroethylene (ETFE), with simple or sandwich structure (double layer or multilayer composite), with or without an adhesive layer or a cement agent layer.
